(19) United States
(12) Patent Application Publication
(10) Pub. No.: US 2024/0345985 A1
(43) Pub. Date: Oct. 17, 2024

(54) CONFIGURABLE FPGA ACCESS CONTROL

(71) Applicants: Aditya Katragada, Austin, TX (US); Ashish Gupta, San Jose, CA (US); George Chong Hean Ooi, Bayan Lepas (MY)

(72) Inventors: Aditya Katragada, Austin, TX (US); Ashish Gupta, San Jose, CA (US); George Chong Hean Ooi, Bayan Lepas (MY)

(21) Appl. No.: 18/756,788

(22) Filed: Jun. 27, 2024

(51) Int. Cl. G06F 13/42; G06F 13/40

(52) U.S. Cl. CPC G06F 13/4282; G06F 13/4027

(57) ABSTRACT

Systems or methods of the present disclosure may provide systems and techniques for controlling access to components and resources of an IC device by multiple tenants. For example, a method may include: receiving access control instructions defining a first mapping between one or more tenants and respective security attributes and a second mapping between one or more agent identifiers and respective access permissions; receiving a communication intended for a target component of the IC device; determining an origin tenant from which the communication originated; determining a security attribute associated with the origin tenant based on the first mapping; and sending the communication and an agent identifier comprising the security attribute and an initiator bridge identifier to a corresponding target bridge, wherein the corresponding target bridge is configured to grant or deny access of the communication to the target component based on the agent identifier and the second mapping.

### BACKGROUND

The present disclosure relates generally to integrated circuit devices. More particularly, the present disclosure relates to controlling access to components of an integrated circuit device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit (IC) devices, such as field-programmable gate arrays (FPGAs), may include various components, such as memory devices, programmable logic blocks, processors, and accelerators. Further, the components may be provisioned such that they may be accessed by multiple initiator components (e.g., processors, input/output devices) and/or used by multiple tenants (e.g., users, applications) concurrently. For example, in a cloud-computing implementation, a cloud-service provider (CSP) may allow multiple tenant applications to use a processor of an IC device to access accelerator resources of the IC device to perform a computation function. However, shared access by multiple tenants to resources of an IC device may expose the tenants and/or an associated CSP to security vulnerabilities.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of an example system in which tenants access components and resources of a field-programmable gate array (FPGA), in accordance with an embodiment of the present disclosure;

FIG. 4 is a block diagram of the system of FIG. 1 in which initiators access components and resources of an FPGA via a network on chip (NoC) of the FPGA, in accordance with an embodiment of the present disclosure;

FIG. 5 is a block diagram of the system of FIG. 1 in which initiator bridges generate agent identifiers based on access control instructions and an origin tenant of a communication, in accordance with an embodiment of the present disclosure;

FIG. 6 is a block diagram of the system of FIG. 1 in which target bridges control access to components and resource of an FPGA based on received agent identifiers and access control instructions, in accordance with an embodiment of the present disclosure;

FIG. 7 is a flow chart of a method for controlling access of tenants to target components of an FPGA, in accordance with an embodiment of the present disclosure; and

FIG. 8 is a is a block diagram of a data processing system including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned, IC devices may include components such as accelerators, memory devices, and programmable logic, and the components may be accessed by tenants, which may include programmed logic circuitry, software components of a processor, devices connected to the IC device, and the like. Further, the tenants may be hosted by an initiator component, such as a processor, programmable logic circuitry, or input/output device of the IC device, and the initiator component may initiate a transaction to a target component to aid the tenant in performing a specific function. In particular, a target component (e.g., an accelerator) may perform the specific function independently from the initiator component and/or more efficiently than another hardware or software component of an IC device and, thus, the initiator component may instruct (e.g., drive) the target component to perform the function as needed. Further, to perform certain functions, such as generating and exchanging cryptographic keys, the target component may accept certain requests, operands, and parameters from an initiator component, and may grant access to resources accessible by the accelerator, such as memory or programmable logic of an FPGA. However, granting such access to multiple tenants concurrently may lead to trust boundary violations, privileging challenges, and the like between tenants sharing use of the accelerator.

Implementing multi-tenancy access control within soft logic of an IC device may be resource intensive, especially in implementations with complex trust boundaries between tenants and/or numerous tenants. Further, tenants may be added or removed from access to target components and/or resources and/or may have varying access specifications, which may alter desired trust boundaries of the IC device and tenants. For example, a CSP may offer subscription-based access to target components via an initiator component associated with the CSP, and may offer different tiers of access, access upgrades, and the like as part of an FPGA-as-a-service (FaaS) model. Thus, access control techniques that may be adjusted as may be desired.

The present systems and techniques relate to embodiments for controlling access to components and resources of an IC device by multiple tenants. In particular, embodiments of the present disclosure may include one or more initiator bridges that may be communicatively connected to one or more initiator components, and each initiator component may include (e.g., host) one or more tenants. As used herein, an initiator component may include a component or system of an IC device such as a processor, programmable logic circuitry, or input/output circuitry, that may host one or more tenants. As used herein, tenants may be understood to mean a user, programmed logic, application, device, or the like that is executed by an initiator component, connected to an IC device via an initiator component, included as part of an initiator component, or otherwise associated with an initiator component. In some cases, the tenants may be different entities (e.g., different users; different agents associated with respective users; different organizations, such as different companies or governments). Each initiator bridge may determine an origin tenant of a connected initiator component from which a communication (e.g., transaction) and a security attribute associated with the origin tenant based on access control instructions. Each initiator bridge may generate an agent identifier for a received communication, and the agent identifier may include an identifier of the initiator bridge and the determined security attribute. Embodiments of the of the present disclosure may also include one or more target bridges that may be communicatively coupled to a target component and/or resource of an IC device. Each target bridge may receive a communication including an agent identifier and may grant or deny access to the target component and/or resource based on the agent identifier. The one or more target bridges may receive the communication from an initiator bridge via interconnection resources included as part of an IC device, such as a network on a chip (NoC), that may direct communications from an initiator bridge to a corresponding target bridge.

The initiator bridges, the target bridges, and the transport circuitry may be programmed via a configuration bitstream generated by design software to define aspects of IC device access control according to a user design. In particular, the design software may generate access control instructions that instruct an initiator bridge to determine security attributes for received communications according to the user design. For example, the design software may instruct an initiator bridge to determine a security attribute based on an initiator identifier, a hard-logic or soft-logic agent or sub-agent of the IC device, a target component, and/or a user-defined identifier. Likewise, the design software may instruct the target bridges to grant or deny access to a connected target component and/or resource according to the user design. The design software may instruct a target bridge to route or block communications based on a range-based table defined by the design software, a selection of cryptographic keys based on initiator attributes, or which logic blocks are connected to a target bridge, as examples. In some examples, the design software may also instruct the transport circuitry to facilitate certain connections between initiator bridges and corresponding target bridges, such that the connections may be initialized or broken within the transport circuitry according to the user design. As such, access control aspects implemented by the initiator bridges, the target bridges, and the transport circuitry may be programmed via the design software to establish trust boundaries within the IC device. Further, via the design software, the trust boundaries may be adjusted to account for, for instance, additional tenants, additional initiators, changes in resource used by the tenant, and so on.

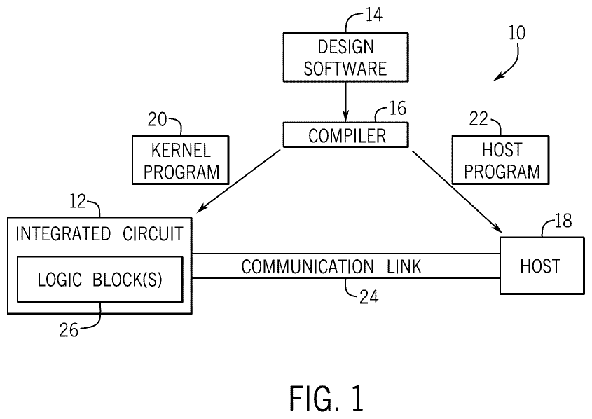

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of one or more logic circuitry 26 on the integrated circuit device 12. The logic circuitry 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

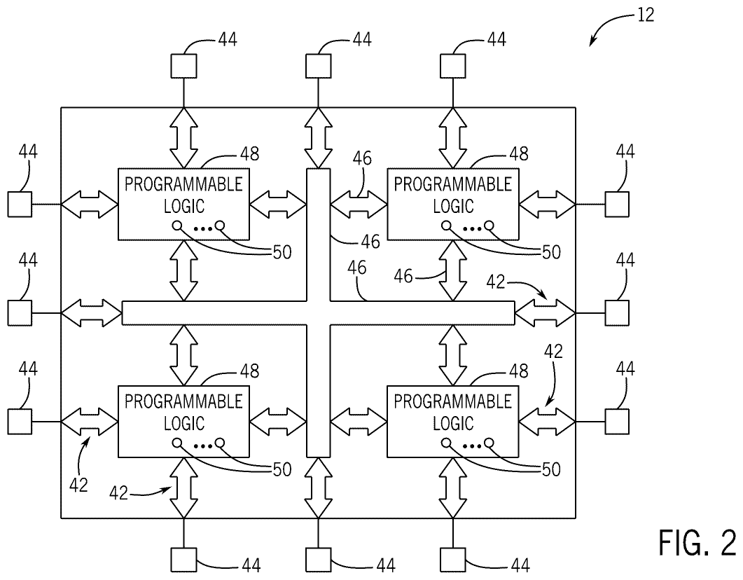

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation and/or application-specific standard product). The integrated circuit device 12 may have input/output circuitry 42 for driving signals off the device and for receiving signals from other devices via input/output pins 44. Interconnection resources 46, such as a network on chip (NoC), global and local vertical and horizontal conductive lines and buses, and/or configuration resources (e.g., hardwired couplings, logical couplings not implemented by designer logic), may be used to route signals and/or transfer packetized data on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

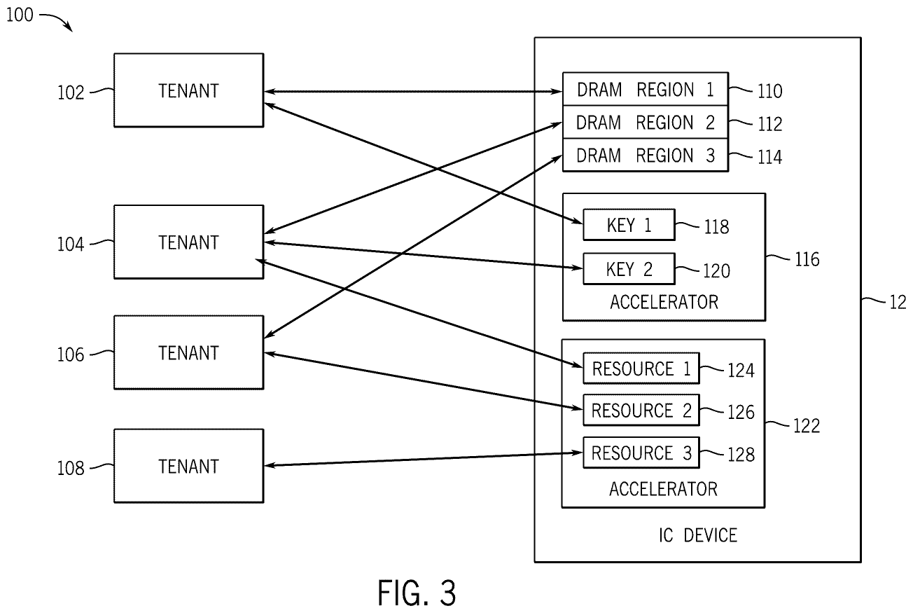

FIG. 3 is a block diagram of a system 100 in which tenants may access target components and target resources of the IC device 12, which may represent the integrated circuit device 12 of FIGS. 1-3, according to trust boundaries using the techniques provided herein. The tenants may include a first tenant 102, a second tenant 104, a third tenant 106, and a fourth tenant 108, which may include, for example, one or more soft logic designs, hardware components (e.g., processors), or software components (e.g., rich execution environments, trusted execution environments), respectively. Target components of the IC device 12 may include memory devices, here illustrated as DRAM regions 110, 112, and 114, that may store data used to perform specific tasks for one or more of the tenants 102, 104, 106, and 108. The target components may also include an accelerator 116 including circuitry that may generate and/or store target resources, here illustrated as a first cryptographic key 118 and a second cryptographic key 120. Additionally, an accelerator 122 of the IC device 12 may generate and/or store a first resource 124, a second resource 126, and a third resource 128 as target resources. Further, while the above-mentioned target components are shown for illustrative purpose, the target components may include other components, such as programmable logic (e.g., soft-logic).

Each of the tenants 102, 104, 106, and 108 may access certain target components and/or target resources of the IC device 12 to perform a specific task, which may define a trust boundary for the tenant. As illustrated, target components of the IC device 12 may include trust boundaries of multiple tenants. For example, a first tenant 102 may access the first cryptographic key 118 and the first DRAM region 110 to perform a first cryptographic key computation. Likewise, a second tenant 104 may access the second cryptographic key 120 and the second DRAM region 112 to perform a second cryptographic key operation. Because the first tenant 102 and second tenant 104 may correspond to different users, owners, or the like, it may be desirable to protect the data associated with a cryptographic key operation of one tenant from access by the other tenant. Further, as illustrated, the second tenant 104, a third tenant 106, and a fourth tenant 108 may access the first resource 124, the second resource 126, and the third resource 128, respectively, which may be generated and/or stored by a common target component, here illustrated as the accelerator 122.

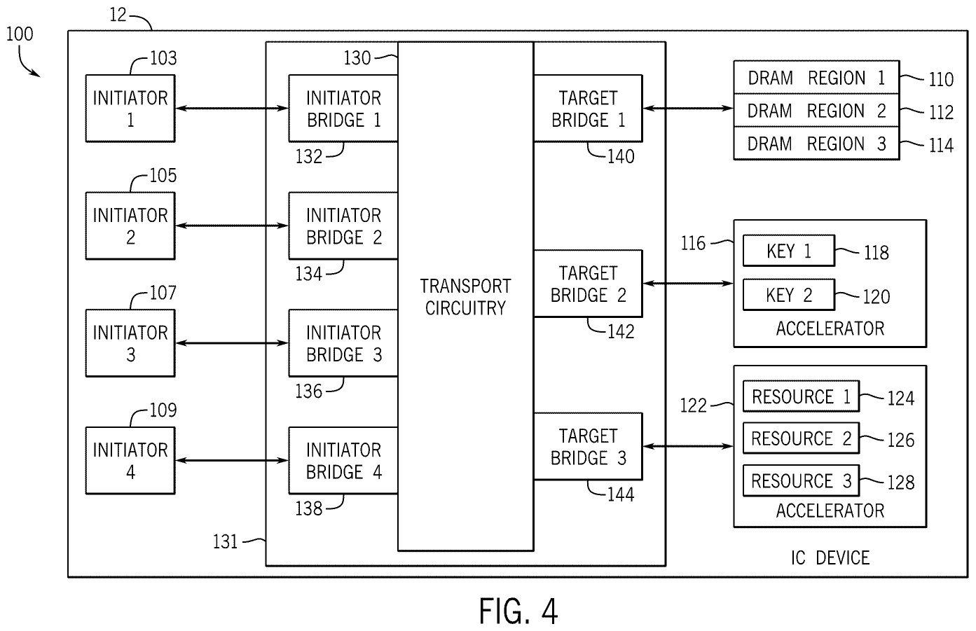

FIG. 4 is a block diagram of the system 100 in which one or more tenants are hosted by initiator components 103, 105, 107, and 109, and the trust boundaries of the system 100 of FIG. 3 are implemented using initiator bridges and target bridges of transport circuitry, here illustrated as transport circuitry 130 of a NoC 131. The transport circuitry 130 of the NoC 131 may include and/or be included as part of the interconnection resources 46 of FIGS. 2-3 used to route signals, such as clock or data signals, through the IC device 12. In the illustrated example, the transport circuitry 130 of the NoC 131 may be connected to initiator bridges 132, 134, 136, and 138. The initiator bridges 132, 134, and 136 may be part of an address space of the NoC 131 that may each be communicatively coupled to the first initiator component 103, the second initiator component 105, the third initiator component 107, or the fourth initiator component 109. As mentioned, each initiator component may host multiple tenants, and the initiator bridges may determine a security attribute for a communication based on a determined origin tenant of the multiple tenants. That is, an initiator bridge may determine varying security attributes for communications received from an initiator component based on an origin tenant determined to have initiated the communication, as will be described below. Further, the initiator bridges may determine security attributes for received communications according to a user design as instructed by design software that may program the IC device 12.

The NoC 131, along with the transport circuitry 130, may include one or more programmable target bridges that may receive communications and grant or deny access to a target component and/or route the communications based on an agent identifier of the communication. In the illustrated example, the NoC 131 includes a first target bridge 140 communicatively coupled to the first DRAM region 110, the second DRAM region 112, and the third DRAM region 114, a second target bridge 142 communicatively coupled to the accelerator 116, and a third target bridge communicatively coupled to the accelerator 122. In some examples, each of the target bridges 140, 142, and 144 may exchange communications with any of the initiator bridges 132, 134, 136, or 138 via the transport circuitry 130. That is, the transport circuitry 130 may include a fully connected network between the initiator bridges 132, 134, 136, and 138. Each of the target bridges may control access of a received communication to a target component based on an agent identifier and a user design (e.g., access control design) as instructed by design software. For example, the target bridge 142 may implement a range-based checking of received agent identifiers based on a range table defined by the design software to grant or deny access to a connected resource, such as the first cryptographic key 118 of the accelerator 116. Additionally or alternatively, a target bridge may route a communication and agent identifier to a connected component (e.g., without implementing access control functions), and the component may, based on the agent identifier, implement access control functions to grant or deny access to a target resource.

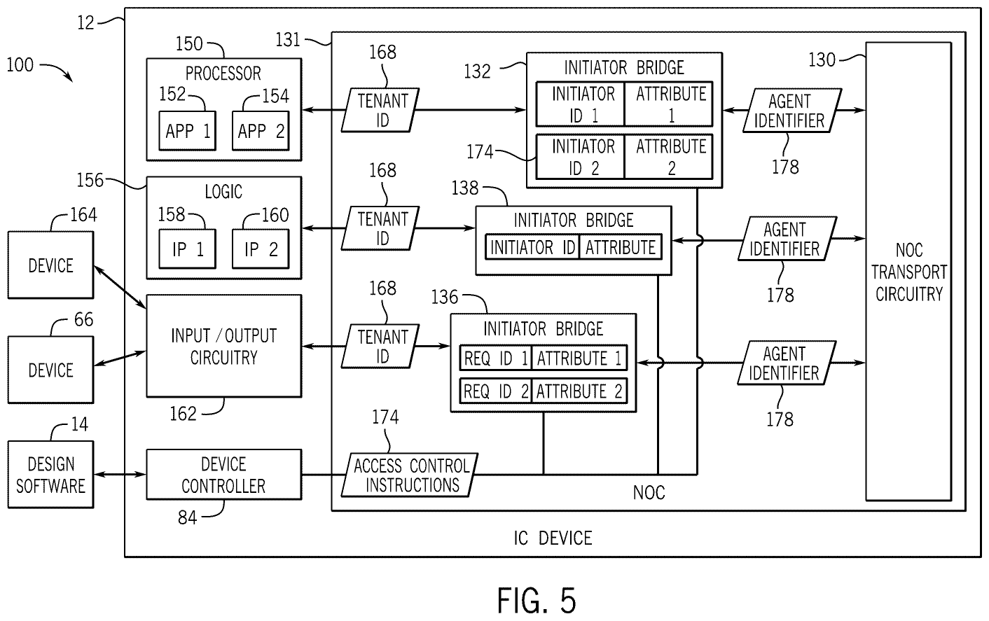

FIG. 5 is a block diagram of the system 100 in which initiator bridges generate agent identifiers based on access control instructions and an origin tenant of a communication. In the illustrated example, the initiator components include a processor 150 hosting a first application 152 and a second application 154 as tenants, programmable logic circuitry 156 hosting programmed logic circuitry 158 and programmed logic circuitry 160 as tenants, and input/output circuitry 162 hosting a first device 164 and a second device 166 as tenants. Further, the IC device 12 includes a device controller 84 that may, based on a user design of the design software 14, instruct the initiator bridges 132, 134, and 136 to determine certain security attributes for received communications.

The processor 150, the programmable logic circuitry 156, and/or the input/output circuitry 162 may send communications originating from a tenant to a connected initiator bridge of the initiator bridges 132, 134, and 136, and the communication may include a tenant identifier (ID) 168. For example, for communications originating from the first application 152, the processor may include a tenant ID 168 associated with the first application, and may include a tenant ID 168 associated with the second application 154 with communications originating from the second application 154. Each initiator component may generate the tenant ID 168 based on a suitable access control protocol. For example, the processor 150 and/or the programmable logic circuitry 156 may generate the tenant ID 168 based on a page table access control implemented by a memory management unit (MMU) and/or address map of the processor 150 and/or the programmable logic circuitry 156. Additionally, the tenant ID 168 may also include one or more advanced extensible interface (AXI) access control attributes. Further, the tenant ID 168 of the processor 150 may be driven by a software component with elevated privileges, such as a trusted execution environment of the processor 150. Similarly, the input/output circuitry 162 may generate a tenant ID 168 based on, for example, a root port corresponding to the first device 164 or the second device 166.

Moving on, an initiator bridge 132, 134, or 136 may receive access control instructions 174 defined by the design software 14 from the device controller 84, and the initiator bridges 132, 134, and 136 may generate agent identifiers 178 based on the access control instructions 174 and the tenant ID 168 included with a communication from an initiator component. More particularly, each agent identifier may include a bridge identifier that identifies an initiator bridge and which may be programmed and/or stored in the initiator bridges 132, 134, and 136. Each agent identifier may also include a tenant security attribute, which may be determined based on the access control instructions. The access control instructions 174 may include, for example, instructions to generate a tenant security attribute according to a mapping 176 of tenant IDs 168 to tenant security attributes. Further, access control instructions 174 sent to each initiator bridge may differ based on a desired access control configuration. For example, access control instructions 174 sent to the first initiator bridge 132 may be specifically programmed to control access of communications from the first application 152 and the second application 154. The mapping may, for example, include an indication of a tenant security attribute for each tenant ID 168 that may be received by the initiator bridges 132, 134, and 136. In any case, the initiator bridges 132, 134, 136 may, for each communication received from an initiator component, combine the bridge identifier and tenant security attribute to form an agent identifier 178 and may append the agent identifier to the communication or combine the agent identifier and the communication. The agent identifier 178 may be sent with a communication by an initiator bridge 132, 134, or 136 to one or more corresponding target bridges via the transport circuitry 130.

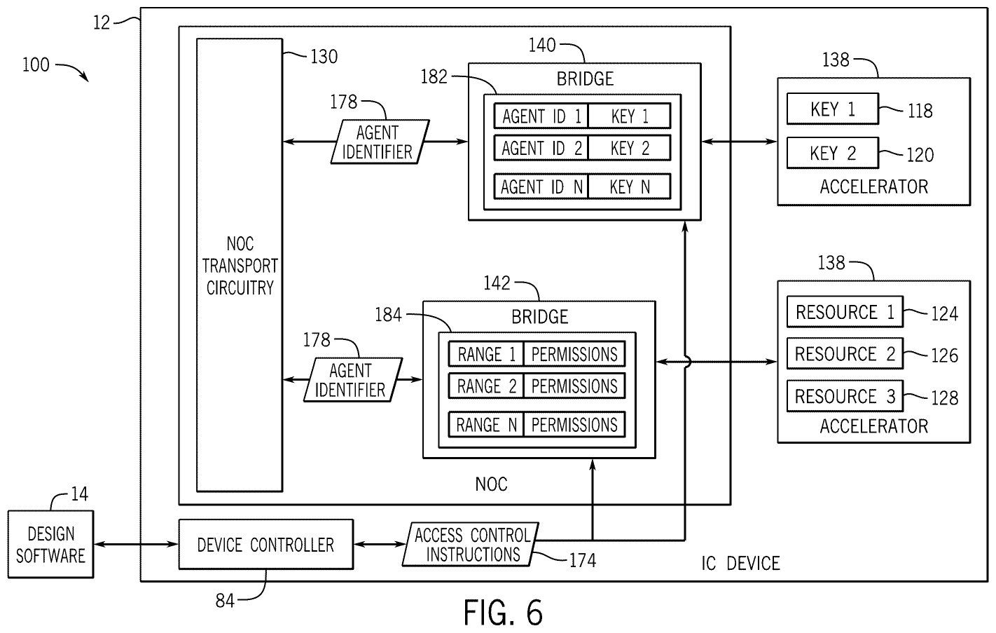

The one or more corresponding target bridges may receive a communication with an agent identifier, may implement further access control based on the agent identifier and access control instructions defined by design software, and may route the communication with the agent identifier to a target component or resource of the FPGA. To illustrate, FIG. 6 is a block diagram of the system 100 in which communications including agent identifiers 178 are received by the target bridges 140 and 142 via the transport circuitry 130. Additionally, the target bridges may receive access control instructions 174 defined by the design software 14 via the device controller 84.

As may be appreciated, the access control instructions 174 sent to the target bridges may differ from the access control instructions 174 sent to the initiator bridges 132, 134, and 136 of FIG. 5. In an example, the access control instructions 174 sent to the target bridges may define a course-grained access control, such as a range-based checking of an agent identifier sent from an initiator bridge. As illustrated with the target bridge 142, the range-based checking may include referencing a range table 184 programmed according to user design of the design software 14 that defines permissions based on a range of agent identifiers that the agent identifier 178 is determined to be a part of. Based on the permissions corresponding to the determined range of agent identifiers, the target bridge 142 may grant or deny access to a connected component, here illustrated as the accelerator 122. As another example of access control that may be implemented by the target bridges, the target bridge 142 may reference a cryptographic key table 182 that maps agent identifiers to cryptographic keys. Based on the cryptographic key associated with the agent identifier as defined by the cryptographic key table 182, the communication with the agent identifier 178 may be granted or denied access to the first cryptographic key 118 or the second cryptographic key 120.

Other mappings are envisioned. For example, a correspondence between agent identifiers and PCIe functions of components connected to the target bridges may be programmed as part of the design software 14 and sent as the access control instructions 174. Alternatively, the mapping may include a correspondence between agent identifiers and soft logic targets connected to the target bridges. In any case, based on the agent identifier 178 that uniquely identifies a tenant (e.g., agent) of an initiator component, the target bridges 140 and/or 142 may implement access control to the accelerators 116 and 122 as defined by the received access control instructions 174. As such, access control based on the agent identifier as defined by the access control instructions 174 may control access of one or more tenants (e.g., the first application 152, the second application 154, the programmed logic circuitry 158, the first device 164, and so on) to resources and components of the FPGA connected to target bridges.

In some examples, the agent identifier 178 or portions of the agent identifier 178 may be sent with a communication from a target bridge to a connected target component, and the target component may implement further access control to target resources of the target component. For example, the target bridge 140 may forward a tenant security attribute of the agent identifier (e.g., as determined by an initiator bridge 132, 134, or 136) to the accelerator 116, and the accelerator 116 may grant or deny access to the first cryptographic key 118 or the second cryptographic key 120 based on the tenant security attribute. To perform the further access control, a target component may include store page tables, range registers, and the like to implement techniques similar to the access control performed by the target bridges. Further, in some examples, target components such as the accelerator 116 and the accelerator 122 may receive access control instructions (e.g., the access control instructions 174) that cause the target components to implement the further access control according to a user design implemented in, for example, the design software 14.

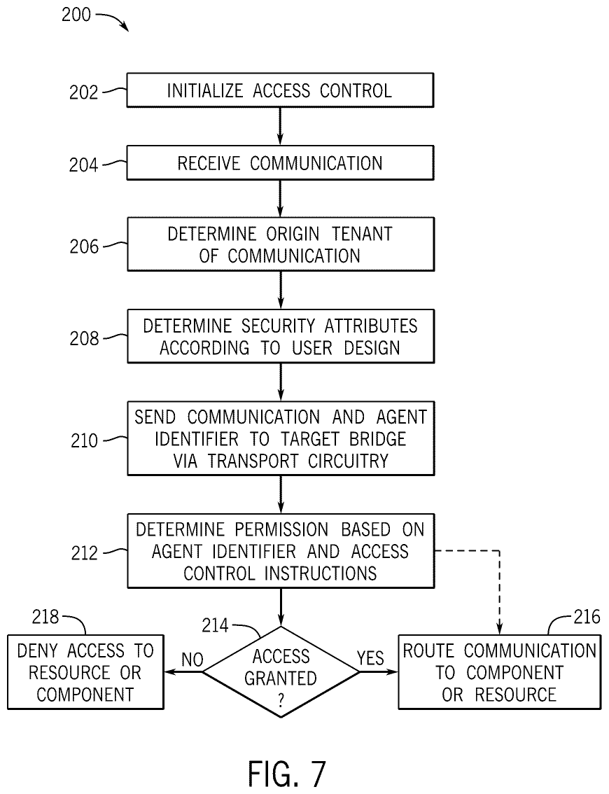

FIG. 7 is a flow chart of a method 200 for controlling access of tenants (e.g., the first application 152) of initiator components (e.g., the processor 150) to components or resources (e.g., the accelerator 116 or the first cryptographic key 118) of an IC device, such as the IC device 12. The method may begin, in block 202, access control may be initialized. This may include programming the initiator bridges 132, 134, and 136 and the target bridges 140 and 142 by sending the access control instructions 174 as defined by design software 14. The access control instructions 174 may cause the initiator bridges 132, 134, and 136 to determine tenant security attributes based on a tenant ID of a communication according to a user design of the design software 14. Further, the access control instructions 174 may cause the target bridges 140 and 142 to grant or deny permission based on an agent identifier 178 of a communication according to the user design. Additionally, access control instructions 174 sent to each of the initiator bridges 132, 134, and 136 and each of the target bridges 140 and 142 may differ based on a user design. For example, a user design may specify that communications from the first application 152 be given different tenant security attributes than communications from the second application 154. The user design may also specify that communications that include an agent identifier within a range of agent identifiers be granted or denied access to a resource or component of the IC device 12.

In block 204, a communication is received at an initiator bridge from an initiator component. The communication may be initiated by a tenant (e.g., an origin tenant) of the initiator component from which the communication is sent. The communication may include, for example, a transaction attempt initiated by an application, programmed logic circuitry, or device of an initiator component, and may be associated with, for example, a request for an accelerator to perform a computation function. As such, the communication may indicate a target component (e.g., an accelerator or DRAM region) and/or a target resource (e.g., a resource of an accelerator) In block 206, an origin tenant of the communication is determined. As described herein, an initiator component (e.g., the input/output circuitry 162) may determine and/or generate a tenant ID based on a determination of a tenant from which a communication is initiated. As such, the initiator bridge may determine the origin tenant based on a tenant ID associated with a tenant hosted by an initiator component communicatively coupled to the initiator bridge. For example, the input/output circuitry 162 may determine the first device 164 is an origin tenant of a communication, and may include a tenant ID indicating the first device with a communication sent to the third initiator bridge 136. Accordingly, the communication received at the third initiator bridge 136 from the input/output circuitry 162 may include a tenant ID 168 that indicates the first device 164.

In block 208, tenant security attributes of an origin tenant (e.g., respective security attributes of a respective tenant) may be determined according to a user design. In particular, the initiator bridge 132, 134, or 136 may determine tenant security attributes of a communication based on the origin tenant and access control instructions 174 defined by design software 14. The access control instructions may, for example, define a mapping between origin tenants and tenant security attributes. As such, the determined tenant security attributes may correspond to and uniquely identify an origin tenant.

In block 210, an initiator bridge 132, 134, or 136 may send the communication including an agent identifier 178 to a corresponding target bridge of the target bridges 140 and 142 via transport circuitry 130. As described herein, the agent identifier may include the tenant security attributes determined in block 208 along with an initiator bridge identifier that uniquely identifies an initiator bridge 132, 134, or 136. The transport circuitry 130 may be included as part of interconnection resources (e.g., of a NoC) that may route signals and/or data between components other than the initiator bridges 132, 134, and 136 and/or may route signals other than communications with agent identifiers.

In block 212, the target bridge 140 and/or the target bridge 142 may implement access control of the communication by determining permissions (e.g., respective access permissions) associated with a received agent identifier 178. The target bridges 140 and 142 may determine permissions based on a user design implemented in the design software 14 and defined by the access control instructions received in block 202. In block 214, the target bridges 140 and 142 may determine whether to grant or deny access to the accelerator 116 and/or the accelerator 122 based on, for example range-based checking of an agent identifier, a mapping between agent identifiers and cryptographic keys (e.g., of the accelerator 116), and the like, which may be defined by the received access control instructions. If access is granted, in block 216, the communication and/or the agent identifier associated with the communication may be routed to a target component or target resource of a component connected to a target bridge 140 or 142. If, however, access is not granted based on the permissions associated with the agent identifier, access by the communication may be blocked in block 218.

It should be noted that, according to certain user designs defined by the access control instructions, the target bridges 140 and/or 142 may grant access of to communications to a target component or target resource regardless of the agent identifier and/or permission of the agent identifier, as illustrated by the dashed line between blocks 212 and 216. For example, according to a user design, the target bridges may forward all communications to a connected component such that the connected component may implement access control to one or more resources of the connected component. In another example, according to another user design, the target bridges may implement cursory checks of the agent identifier and/or the communication. For example, access control instructions may instruct the target bridge 140 to forward all communications with an agent identifier of a proper format, length, or the like to the accelerator 116, and may block communications of an improper format or length from reaching the accelerator 116.

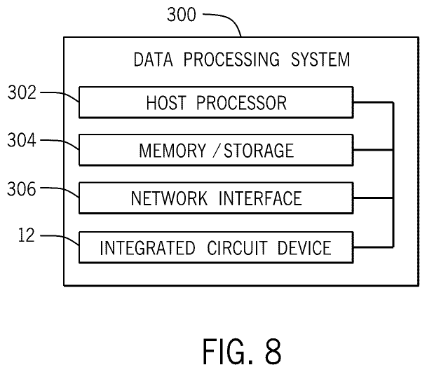

Bearing the foregoing in mind, the integrated circuit device 12 may be a component included in a data processing system, such as a data processing system 300, shown in FIG. 8. The data processing system 300 may include the integrated circuit device 12 (e.g., a programmable logic device), a host processor 304 (e.g., a processor), memory and/or storage circuitry 306, and a network interface 308. The data processing system 300 may include more or fewer components (e.g., electronic display, designer interface structures, ASICs). Moreover, any of the circuit components depicted in FIG. 8 may include integrated circuits (e.g., integrated circuit device 12). The host processor 304 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 306 may include random access memory (RAM), read-only memory (ROM), one or more hard drives, flash memory, or the like. The memory and/or storage circuitry 306 may hold data to be processed by the data processing system 300. In some cases, the memory and/or storage circuitry 306 may also store configuration programs (bit streams) for programming the integrated circuit device 12. The network interface 308 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

In one example, the data processing system 300 may be part of a data center that processes a variety of different requests. For instance, the data processing system 300 may receive a data processing request via the network interface 308 to perform encryption, decryption, machine learning, video processing, voice recognition, image recognition, data compression, database search ranking, bioinformatics, network security pattern identification, spatial navigation, digital signal processing, or some other specialized task.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. A method, comprising: receiving, at an integrated circuit (IC) device, access control instructions defining a first mapping between one or more tenants and respective security attributes and a second mapping between one or more agent identifiers and respective access permissions; receiving, at the integrated circuit (IC) device, a communication intended for a target component of one or more target components of the integrated circuit (IC) device; determining, via the integrated circuit (IC) device, an origin tenant of the one or more tenants from which the communication originated; determining, via the integrated circuit (IC) device, a security attribute of the respective security attributes associated with the origin tenant based on the first mapping; and sending, via the integrated circuit (IC) device, the communication and an agent identifier comprising the security attribute and an initiator bridge identifier to a corresponding target bridge connected to the target component of the one or more target components, wherein the corresponding target bridge is configured to grant or deny access of the communication to the target component based on the agent identifier and the second mapping.

EXAMPLE EMBODIMENT 2. The method of example embodiment 1, wherein the first mapping and second mapping are part of a user design to be implemented on the integrated circuit (IC) device that defines one or more trust boundaries between the one or more tenants.

EXAMPLE EMBODIMENT 3. The method of example embodiment 2, wherein the user design is generated in design software and sent to the integrated circuit (IC) device as the access control instructions.

EXAMPLE EMBODIMENT 4. The method of example embodiment 1, wherein the origin tenant accesses the integrated circuit (IC) device via an initiator component connected to an initiator bridge of one or more initiator bridges of the integrated circuit (IC) device.

EXAMPLE EMBODIMENT 5. The method of example embodiment 4, wherein the initiator bridge identifier indicates the initiator bridge of the one or more initiator bridges of the integrated circuit (IC) device.

EXAMPLE EMBODIMENT 6. The method of example embodiment 4, wherein the initiator component comprises a processor, wherein the one or more tenants comprise one or more applications executed by the processor, and wherein the origin tenant comprises an application of the one or more application.

EXAMPLE EMBODIMENT 7. The method of example embodiment 4, wherein the initiator component comprises programmable logic circuitry, wherein the one or more tenants comprise one or more programmed logic circuitries, and wherein the origin tenant comprises a programmed logic circuitry of the one or more programmed logic circuitries.

EXAMPLE EMBODIMENT 8. The method of example embodiment 4, wherein the initiator component comprises input/output (I/O) circuitry, wherein the one or more tenants comprise one or more devices connected to the integrated circuit (IC) device via the I/O circuitry, and wherein the origin tenant comprises a device of the one or more devices.

EXAMPLE EMBODIMENT 9. The method of example embodiment 1, wherein the communication comprises a tenant identifier, and wherein the origin tenant of the one or more tenants is determined based on the tenant identifier.

EXAMPLE EMBODIMENT 10. An integrated circuit, comprising: a target component; and a network on chip (NoC) configurable to grant or deny access by an initiator to the target component.

EXAMPLE EMBODIMENT 11. The integrated circuit of example embodiment 10, wherein the target component is configurable to be accessed by an initiator.

EXAMPLE EMBODIMENT 12. The integrated circuit of example embodiment 10, wherein the network on chip (NoC) is configured to facilitate packetized data transfer between the initiator and the target component.

EXAMPLE EMBODIMENT 13. The integrated circuit of example embodiment 10, wherein the network on chip (NoC) is configured to: receive access control instructions; receive a communication from the initiator intended for the target component; determine an origin tenant from which the communication originated; determine a security attribute associated with the origin tenant based on the access control instructions; and grant or deny access by the initiator to the target component based on the security attribute and an initiator bridge identifier associated with an initiator bridge communicatively coupled to the initiator.

EXAMPLE EMBODIMENT 14. The integrated circuit of example embodiment 13, wherein the access control instructions define a first mapping between one or more tenants and respective security attributes, and wherein the network on chip (NoC) is configured to: determine the security attribute of the respective security attributes associated with the origin tenant based on the first mapping.

EXAMPLE EMBODIMENT 15. The integrated circuit of example embodiment 10, wherein the network on chip (NoC) is configured to: receive access control instructions; receive a communication from the initiator intended for the target component and an agent identifier associated with the communication; and grant or deny access by the initiator to the target component based on the agent identifier associated with the communication and the access control instructions.

EXAMPLE EMBODIMENT 16. The integrated circuit of example embodiment 15, wherein the access control instructions define a second mapping between one or more agent identifiers and respective access permissions.

EXAMPLE EMBODIMENT 17. A tangible, non-transitory, and computer-readable medium, storing instructions thereon, wherein the instructions, when executed, are to cause a processor to: receive access control instructions defining a first mapping between one or more tenants and respective security attributes and a second mapping between one or more agent identifiers and respective access permissions; receive a communication intended for a target component of one or more target components of a programmable logic device; determine an origin tenant of the one or more tenants from which the communication originated; determine a security attribute of the respective security attributes associated with the origin tenant based on the first mapping; and send the communication and an agent identifier comprising the security attribute and an initiator bridge identifier to a corresponding target bridge connected to the target component of the one or more target components, wherein the corresponding target bridge is configured to grant or deny access of the communication to the target component based on the agent identifier and the second mapping.

EXAMPLE EMBODIMENT 18. The tangible, non-transitory, and computer-readable medium of example embodiment 16, wherein the second mapping comprises a correspondence between one or more ranges of agent identifiers and the respective access permissions, and wherein the corresponding target bridge is configured to grant or deny access of the communication to the target component based on the second mapping by: determining a range of agent identifiers of the one or more ranges of agent identifiers the agent identifier is part of; and determining access permissions of the respective access permissions associated with the range of agent identifiers of the one or more ranges of agent identifiers based on the second mapping.

EXAMPLE EMBODIMENT 19. The tangible, non-transitory, and computer-readable medium of example embodiment 16, wherein the second mapping comprises a correspondence between one or more ranges of agent identifiers and the respective access permissions, and wherein the corresponding target bridge is configured to grant or deny access of the communication to the target component based on the second mapping by: determining a range of agent identifiers of the one or more ranges of agent identifiers that comprises the agent identifier; and determining access permissions associated with the range of agent identifiers based on the second mapping.

EXAMPLE EMBODIMENT 20. The tangible, non-transitory, and computer-readable medium of example embodiment 16, wherein the second mapping comprises a correspondence between one or more agent identifiers and one or more target resources of the target component, and wherein the corresponding target bridge is configured to grant or deny access of the communication to a target resource of the one or more target resources based on the second mapping.

What is claimed is:

1. A method, comprising:
receiving, at an integrated circuit (IC) device, access control instructions defining a first mapping between one or more tenants and respective security attributes and a second mapping between one or more agent identifiers and respective access permissions;
receiving, at the integrated circuit (IC) device, a communication intended for a target component of one or more target components of the integrated circuit (IC) device;
determining, via the integrated circuit (IC) device, an origin tenant of the one or more tenants from which the communication originated;
determining, via the integrated circuit (IC) device, a security attribute of the respective security attributes associated with the origin tenant based on the first mapping; and
sending, via the integrated circuit (IC) device, the communication and an agent identifier comprising the security attribute and an initiator bridge identifier to a corresponding target bridge connected to the target component of the one or more target components, wherein the corresponding target bridge is configured to grant or deny access of the communication to the target component based on the agent identifier and the second mapping.

2. The method of claim 1, wherein the first mapping and second mapping are part of a user design to be implemented on the integrated circuit (IC) device that defines one or more trust boundaries between the one or more tenants.

3. The method of claim 2, wherein the user design is generated in design software and sent to the integrated circuit (IC) device as the access control instructions.

4. The method of claim 1, wherein the origin tenant accesses the integrated circuit (IC) device via an initiator component connected to an initiator bridge of one or more initiator bridges of the integrated circuit (IC) device.

5. The method of claim 4, wherein the initiator bridge identifier indicates the initiator bridge of the one or more initiator bridges of the integrated circuit (IC) device.

6. The method of claim 4, wherein the initiator component comprises a processor, wherein the one or more tenants comprise one or more applications executed by the processor, and wherein the origin tenant comprises an application of the one or more application.

7. The method of claim 4, wherein the initiator component comprises programmable logic circuitry, wherein the one or more tenants comprise one or more programmed logic circuitries, and wherein the origin tenant comprises a programmed logic circuitry of the one or more programmed logic circuitries.

8. The method of claim 4, wherein the initiator component comprises input/output (I/O) circuitry, wherein the one or more tenants comprise one or more devices connected to the integrated circuit (IC) device via the I/O circuitry, and wherein the origin tenant comprises a device of the one or more devices.

9. The method of claim 1, wherein the communication comprises a tenant identifier, and wherein the origin tenant of the one or more tenants is determined based on the tenant identifier.

10. An integrated circuit, comprising:
a target component; and
a network on chip (NoC) configurable to grant or deny access by an initiator to the target component.

11. The integrated circuit of claim 10, wherein the target component is configurable to be accessed by an initiator.

12. The integrated circuit of claim 10, wherein the network on chip (NoC) is configured to facilitate packetized data transfer between the initiator and the target component.

13. The integrated circuit of claim 10, wherein the network on chip (NoC) is configured to:
receive access control instructions;
receive a communication from the initiator intended for the target component;
determine an origin tenant from which the communication originated;
determine a security attribute associated with the origin tenant based on the access control instructions; and
grant or deny access by the initiator to the target component based on the security attribute and an initiator bridge identifier associated with an initiator bridge communicatively coupled to the initiator.

14. The integrated circuit of claim 13, wherein the access control instructions define a first mapping between one or more tenants and respective security attributes, and wherein the network on chip (NoC) is configured to:
determine the security attribute of the respective security attributes associated with the origin tenant based on the first mapping.

15. The integrated circuit of claim 10, wherein the network on chip (NoC) is configured to:
receive access control instructions;
receive a communication from the initiator intended for the target component and an agent identifier associated with the communication; and
grant or deny access by the initiator to the target component based on the agent identifier associated with the communication and the access control instructions.

16. The integrated circuit of claim 15, wherein the access control instructions define a second mapping between one or more agent identifiers and respective access permissions.

17. A tangible, non-transitory, and computer-readable medium, storing instructions thereon, wherein the instructions, when executed, are to cause a processor to:
receive access control instructions defining a first mapping between one or more tenants and respective security attributes and a second mapping between one or more agent identifiers and respective access permissions;
receive a communication intended for a target component of one or more target components of a programmable logic device;
determine an origin tenant of the one or more tenants from which the communication originated;
determine a security attribute of the respective security attributes associated with the origin tenant based on the first mapping; and
send the communication and an agent identifier comprising the security attribute and an initiator bridge identifier to a corresponding target bridge connected to the target component of the one or more target components, wherein the corresponding target bridge is configured to grant or deny access of the communication to the target component based on the agent identifier and the second mapping.

18. The tangible, non-transitory, and computer-readable medium of claim 16, wherein the second mapping comprises a correspondence between one or more ranges of agent identifiers and the respective access permissions, and wherein the corresponding target bridge is configured to grant or deny access of the communication to the target component based on the second mapping by:
determining a range of agent identifiers of the one or more ranges of agent identifiers the agent identifier is part of; and
determining access permissions of the respective access permissions associated with the range of agent identifiers of the one or more ranges of agent identifiers based on the second mapping.

19. The tangible, non-transitory, and computer-readable medium of claim 16, wherein the second mapping comprises a correspondence between one or more ranges of agent identifiers and the respective access permissions, and wherein the corresponding target bridge is configured to grant or deny access of the communication to the target component based on the second mapping by:
determining a range of agent identifiers of the one or more ranges of agent identifiers that comprises the agent identifier; and
determining access permissions associated with the range of agent identifiers based on the second mapping.

20. The tangible, non-transitory, and computer-readable medium of claim 16, wherein the second mapping comprises a correspondence between one or more agent identifiers and one or more target resources of the target component, and wherein the corresponding target bridge is configured to grant or deny access of the communication to a target resource of the one or more target resources based on the second mapping.
